(19) United States
(12) Patent Application Publication
(10) Pub. No.: US 2018/0094354 A1
(43) Pub. Date: Apr. 5, 2018

(54) ETCHING DEVICES AND ETCHING METHODS

(71) Applicant: Wuhan China Star Optoelectronics Technology Co., Ltd., Wuhan, Hubei (CN)

(72) Inventor: Jiangbo YE, Shenzhen, Guangdong (CN)

(73) Assignee: Wuhan China Star Optoelectronics Technology Co., Ltd., Wuhan, Hubei (CN)

(21) Appl. No.: 15/102,868

(22) PCT Filed: May 25, 2016
(86) PCT No.: PCT/CN2016/083293

§ 371 Date: Jun. 8, 2016

(30) Foreign Application Priority Data
Apr. 18, 2016 (CN) 201610238916.X

(51) Int. Cl. C23F 1/08; G02F 1/13

(52) U.S. Cl. CPC C23F 1/08; G05B 2219/45212; G02F 1/1303

(57) ABSTRACT

An etching device includes a control unit, a transportation portion, a feeding portion, a conveyor belt, a plurality of cleaning bins spaced apart from each other, a first etching slot, a second etching slot, and a third etching slot. The transportation portion is arranged on one side of the cleaning bin facing away the first etching slot. The feeding portion is arranged at an outer side of a dry bin. The conveyor belt connects between the transportation portion and the feeding portion. The etching device further includes a fourth transportation bin, a first transportation bin, a second transportation bin, and a third transportation bin. The first transportation bin is arranged at one side of the first etching slot, and the first transportation bin connects with the first etching slot.

### CROSS REFERENCE

This application claims the priority of Chinese Patent Application No. 201610238916.X, entitled “Etching devices and etching methods”, filed on Apr. 18, 2016, the disclosure of which is incorporated herein by reference in its entirety.

### FIELD OF THE INVENTION

The present invention relates to a liquid crystal display technology field, and more particularly to an etching device for patterning array substrates.

### BACKGROUND OF THE INVENTION

Devices cost of low temperature poly-silicon (LTPS) is greater than conventional thin film transistors (TFTs) for the reason that the number of masking of LTPS is more than that of the TFTs. Due to the precision and high-resolution limitations of the products, dry etching devices are adopted in most of the etching processes. The dry etching device is greater when wet etching device in terms of controlling the line width, and thus has played an important role in LTPS manufacturing process. During the operations, the gate and the common/pixel electrodes may share the same wet etching device. Usually, as the film thicknesses of the two components are much different, and thus the etching degree cannot be controlled in accordance with the line width. At the same time, as the gate is the pure Mo, and the common electrode and the pixel electrode are Al, the etching rate of the Mo is greater than that of the Al when the temperature is the same. Thus, it is not applicable to adopt the same device to perform the manufacturing process with respect to the two components, which results in increasing manufacturing time, device, and cost.

### SUMMARY OF THE INVENTION

The technical issue that the embodiment of the present invention solves is to provide an etching device for etching metal layers having different etching rates of the LTPS array substrates.

In one aspect, an etching device for etching array substrates includes: a control unit, a transportation portion, a feeding portion, a conveyor belt, a plurality of cleaning bins spaced apart from each other, a first etching slot, a second etching slot, and a third etching slot, the transportation portion is arranged on one side of the cleaning bin facing away the first etching slot, the feeding portion is arranged at an outer side of a dry bin, the conveyor belt connects between the transportation portion and the feeding portion, the etching device further includes a fourth transportation bin, a first transportation bin, a second transportation bin, and a third transportation bin, the first transportation bin is arranged at one side of the first etching slot, and the first transportation bin connects with the first etching slot, the second transportation bin is arranged at one side of the second etching slot, and the second transportation bin connects with the second etching slot, the third transportation bin is arranged at one side of the second etching slot, and the third transportation bin connects with the second etching slot, the fourth transportation bin is arranged on one side of the cleaning bins, and the fourth transportation bin, the first transportation bin, and the third transportation bin are connected.

Wherein a switchable blocking door is arranged between the cleaning bins and the first etching slot, between the first etching slot and the second etching slot, between the second etching slot and the third etching slot, between the third etching slot and a washing slot, and between the washing slot and the dry bin.

Wherein a cleaning device is configured at two sides of the blocking door of the cleaning bins.

Wherein the fourth transportation bin, the first transportation bin, the second transportation bin, and the third transportation bin are on the same row, the cleaning bins, the first etching slot, the second etching slot, the third etching slot, the washing slot, and the dry bin are on the same row parallel to the row where the fourth transportation bin, the first transportation bin, the second transportation bin, and the third transportation bin are located.

Wherein a transporting device is respectively configured between the first transportation bin and the first etching slot, between the second transportation bin and the second etching slot, between the third transportation bin and the third etching slot, and between the fourth transportation bin and the cleaning bins.

Wherein the feeding portion includes a chamber and a lifting component within the chamber, and the lifting component is configured for transporting the array substrate to be etched and for arranging the array substrate within the cleaning bins.

Wherein each of the fourth transportation bin, the first transportation bin, the second transportation bin, and the third transportation bin includes a bin and a travelling belt configured within the bin.

Wherein a transporting direction of the transporting device between the first transportation bin and the first etching slot is perpendicular to the transporting direction of a transporting band of the first transportation, and the transporting direction of the transporting device between the fourth transportation bin and the cleaning bin is perpendicular to the transporting direction of a transporting band of the fourth transportation bin.

Wherein the etching device includes a washing slot and a dry bin, and the washing slot and the dry bin are arranged at one side of the second etching slot facing away the second etching slot.

In another aspect, an etching method of array substrates includes: configuring a plurality of predetermined etching paths by a control unit, wherein the predetermined etching path includes: passing through cleaning bins through a fourth transportation bin, a first transportation bin, and a second etching slot, and entering a third etching slot; and directly entering a first etching slot, the second etching slot and the third etching slot; transporting the array substrate to be etched into a conveyor belt via a transportation portion, and transporting the array substrate to a feeding portion via the conveyor belt; transporting the array substrate to be etched into the cleaning bin by the feeding portion; selecting a corresponding predetermined etching path by the control unit in accordance with an etching amount of an etched metal layer of the array substrate, and etching the array substrate; and transporting the etched array substrate into the washing slot and drying the array substrate.

In view of the above, the etching device may select one or a plurality of etching slots to conduct the etching process in accordance with the etching rate. As such, only one etching device is needed regardless the number of the configured etching slots. In this way, the user operations are not needed so as to reduce the time and the cost of the manufacturing process.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view of the etching device in accordance with one embodiment.

FIG. 2 is a flowchart of the etching method in accordance with one embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

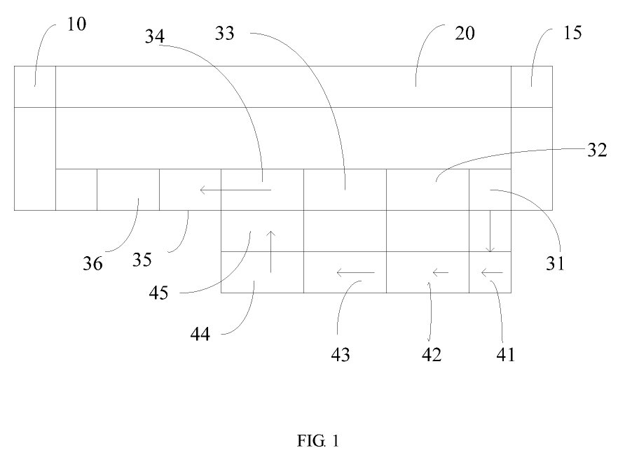

Referring to FIG. 1, the etching device is configured for etching the low temperature polysilicon (LTPS) array substrates. In the embodiment, the gate and the common electrode of the array substrate are taken as examples. The gate is pure Mo, and the common electrode is the AL. The materials and the attributes, such as the line width, of the two metal layers on the same substrate are not the same, such that the etching device having the one etching rate may not be adopted to conduct the etching process. That is, at least two etching devices have to be adopted. Alternatively, the etching process may be conducted by users to select different etching slots, which increases the operation time. In the embodiment, the etching device includes a control unit (not shown), a transportation portion 10, a feeding portion 15, a conveyor belt 20, a plurality of cleaning bins 31 spaced apart from each other, a first etching slot 32, a second etching slot 33, and a third etching slot 34, a washing slot 35 and a dry bin 36. The transportation portion 10 is arranged on one side of the cleaning bin 31 facing away the first etching slot 32. The feeding portion 15 is arranged at an outer side of the dry bin 36. The conveyor belt 20 connects between the transportation portion 10 and the feeding portion 15. The etching device further includes a fourth transportation bin 41, a first transportation bin 42, a second transportation bin 43, and a third transportation bin 44. The first transportation bin 42 is arranged at one side of the first etching slot 32, and the first transportation bin 42 may connect with the first etching slot 32. The second transportation bin 43 is arranged at one side of the second etching slot 33, and the second transportation bin 43 may connect with the second etching slot 33. The third transportation bin 44 is arranged at one side of the second etching slot 33, and the third transportation bin 44 may connect with the second etching slot 34. The fourth transportation bin 41 is arranged on one side of the cleaning bins 31. The fourth transportation bin 41, the first transportation bin 42, and the third transportation bin 44 are connected. The washing slot 35 and the dry bin 36 are arranged at one side of the second etching slot 33 facing away the second etching slot 33.

In the embodiment, the transportation portion 10 and the feeding portion 15 are lifting devices. The feeding portion 15 includes a chamber and a lifting component within the chamber. The lifting component is configured for transporting the array substrate to be etched and for arranging the array substrate within the cleaning bins 31. The conveyor belt 20 connects between the transportation portion 10 and the feeding portion 15. In addition, an ultraviolet (UV) cleaning device is configured above the conveyor belt 20 for removing the organic materials left after the previous manufacturing process.

Further, a switchable blocking door (not shown) may be arranged between the cleaning bins 31 and the first etching slot 32, between the first etching slot 32 and the second etching slot 33, between the second etching slot 33 and the third etching slot 34, between the third etching slot 34 and the washing slot 35, and between the washing slot 35 and the dry bin 36. The blocking door is configured for transporting the array substrate. Further, a cleaning device, such as an air gun, is configured at two sides of the blocking door of the cleaning bins 31. The cleaning device is configured for preventing the feeding portion 15 from erosion by the sour gas within the first etching slot 32 when the blocking door of the cleaning bins 31 is opened such that the array substrate enters the first etching slot 32.

In the embodiment, each of the fourth transportation bin 41, the first transportation bin 42, the second transportation bin 43, and the third transportation bin 44 includes a bin and a travelling belt 45 configured within the bin. The fourth transportation bin 41, the first transportation bin 42, the second transportation bin 43, and the third transportation bin 44 are on the same row. The cleaning bins 31, the first etching slot 32, the second etching slot 33, the third etching slot 34, the washing slot 35, and the dry bin 36 are on the same row parallel to the row where the fourth transportation bin 41, the first transportation bin 42, the second transportation bin 43, and the third transportation bin 44 are located.

In the embodiment, a transporting device is respectively configured between the first transportation bin 42 and the first etching slot 32, between the second transportation bin 43 and the second etching slot 33, between the third transportation bin 44 and the third etching slot 34, and between the fourth transportation bin 41 and the cleaning bins 31. The transporting device between the first transportation bin 42 and the first etching slot 32 is configured for passing the array substrate within the first transportation bin 42 through the blocking door so as to transport the array substrate into the first etching slot 32. Similarly, the transporting device within other transportation bins operates in a similar way as above. The transporting device may be a conveyor belt or a delivery roller.

A transporting direction of the transporting device between the first transportation bin 42 and the first etching slot 32 is perpendicular to the transporting direction of the transporting band of the first transportation bin 42. Similarly, the transporting directions of the transporting devices between the second transportation bin 43 and the second etching slot 33, and between the third transportation bin 44 and the second etching slot 34 are perpendicular to the transporting direction of the transporting band. It can be understood that the transporting bands of the fourth transportation bin 41, the first transportation bin 42, the second transportation bin 43, and the third transportation bin 44 constitute a linear transportation direction. The transporting directions of the transporting devices between the first transportation bin 42 and the first etching slot 32, between the second transportation bin 43 and the second etching slot 33, and between the third transportation bin 44 and the second etching slot 34 are perpendicular to the linear transporting direction.

The etching path may be configured in accordance with the design of the array substrate to be etched. The control unit configures a pre-determined etching path. That is, when the array substrate enters the etching path, the corresponding blocking door is opened. The predetermined path passes through the cleaning bins 31 through the fourth transportation bin 41, the first transportation bin 42, the second etching slot 33 and the second etching slot 34. In another example, the path includes entering the first etching slot 32, the second etching slot 33, and the second etching slot 34.

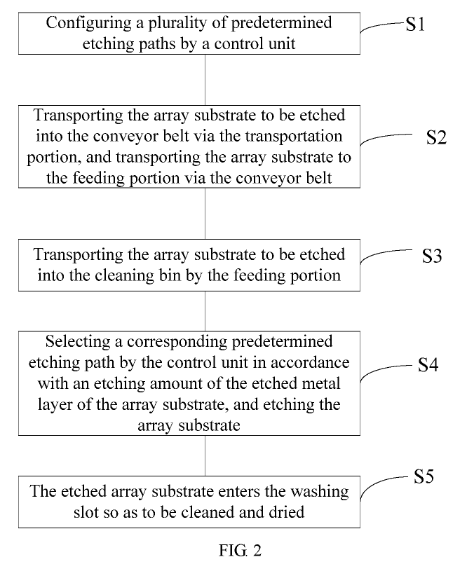

FIG. 2 is a flowchart of the etching method in accordance with one embodiment. The method includes the following steps.

In step S1, configuring a plurality of predetermined etching paths by a control unit.

In step S2, transporting the array substrate to be etched into the conveyor belt 20 via the transportation portion 10, and transporting the array substrate to the feeding portion 15 via the conveyor belt 20.

In step S3, transporting the array substrate to be etched into the cleaning bin 31 by the feeding portion 15.

In step S4, selecting a corresponding predetermined etching path by the control unit in accordance with an etching amount of the etched metal layer of the array substrate, and etching the array substrate.

Taking the gate as one example, the etching rate of the gate is faster due to the gate is pure Mo. In the embodiment, the path passing the cleaning bins 31 through the fourth transportation bin 41, the first transportation bin 42, the second transportation bin 43, and the second etching slot 34 is selected. After the array substrate is arranged within the cleaning bin 31, the array substrate is then arranged within the fourth transportation bin 41 by the transportation device. The array substrate is rotated by 90 degrees within the fourth transportation bin 41, and then enters the first transportation bin 42. Afterward, the array substrate enters the second transportation bin 43, and is rotated by 90 degrees to enter the second etching slot 34. In this way, the array substrate has been etched within the second etching slot 34 and the etching process is completed.

In step S5, the etched array substrate enters the washing slot 35 so as to be cleaned and dried. The etched array substrate has not to be cleaned and dried by manual works such that the time of the manufacturing process may be reduced.

In view of the above, the etching device may select one or a plurality of etching slots to conduct the etching process in accordance with the etching rate. As such, only one etching device is needed regardless the number of the configured etching slots. In this way, the user operations are not needed so as to reduce the time and the cost of the manufacturing process.

Above are embodiments of the present invention, which does not limit the scope of the present invention. Any modifications, equivalent replacements or improvements within the spirit and principles of the embodiment described above should be covered by the protected scope of the invention.

What is claimed is:

1. An etching device for etching array substrates, comprising:
a control unit, a transportation portion, a feeding portion, a conveyor belt, a plurality of cleaning bins spaced apart from each other, a first etching slot, a second etching slot, and a third etching slot, the transportation portion is arranged on one side of the cleaning bin facing away the first etching slot, the feeding portion is arranged at an outer side of a dry bin, the conveyor belt connects between the transportation portion and the feeding portion, the etching device further comprises a fourth transportation bin, a first transportation bin, a second transportation bin, and a third transportation bin, the first transportation bin is arranged at one side of the first etching slot, and the first transportation bin connects with the first etching slot, the second transportation bin is arranged at one side of the second etching slot, and the second transportation bin connects with the second etching slot, the third transportation bin is arranged at one side of the second etching slot, and the third transportation bin connects with the second etching slot, the fourth transportation bin is arranged on one side of the cleaning bins, and the fourth transportation bin, the first transportation bin, and the third transportation bin are connected.

2. The etching device as claimed in claim 1, wherein a switchable blocking door is arranged between the cleaning bins and the first etching slot, between the first etching slot and the second etching slot, between the second etching slot and the third etching slot, between the third etching slot and a washing slot, and between the washing slot and the dry bin.

3. The etching device as claimed in claim 2, wherein a cleaning device is configured at two sides of the blocking door of the cleaning bins.

4. The etching device as claimed in claim 2, wherein the fourth transportation bin, the first transportation bin, the second transportation bin, and the third transportation bin are on the same row, the cleaning bins, the first etching slot, the second etching slot, the third etching slot, the washing slot, and the dry bin are on the same row parallel to the row where the fourth transportation bin, the first transportation bin, the second transportation bin, and the third transportation bin are located.

5. The etching device as claimed in claim 2, wherein a transporting device is respectively configured between the first transportation bin and the first etching slot, between the second transportation bin and the second etching slot, between the third transportation bin and the third etching slot, and between the fourth transportation bin and the cleaning bins.

6. The etching device as claimed in claim 1, wherein the feeding portion comprises a chamber and a lifting component within the chamber, and the lifting component is configured for transporting the array substrate to be etched and for arranging the array substrate within the cleaning bins.

7. The etching device as claimed in claim 5, wherein each of the fourth transportation bin, the first transportation bin, the second transportation bin, and the third transportation bin comprises a bin and a travelling belt configured within the bin.

8. The etching device as claimed in claim 7, wherein a transporting direction of the transporting device between the first transportation bin and the first etching slot is perpendicular to the transporting direction of a transporting band of the first transportation, and the transporting direction of the transporting device between the fourth transportation bin and the cleaning bin is perpendicular to the transporting direction of a transporting band of the fourth transportation bin.

9. The etching device as claimed in claim 1, wherein the etching device comprises a washing slot and a dry bin, and the washing slot and the dry bin are arranged at one side of the second etching slot facing away the second etching slot.

10. An etching method of array substrates, comprising:
configuring a plurality of predetermined etching paths by a control unit, wherein the predetermined etching path comprises:
passing through cleaning bins through a fourth transportation bin, a first transportation bin, and a second etching slot, and entering a third etching slot; and
directly entering a first etching slot, the second etching slot and the third etching slot;
transporting the array substrate to be etched into a conveyor belt via a transportation portion, and transporting the array substrate to a feeding portion via the conveyor belt;
transporting the array substrate to be etched into the cleaning bin by the feeding portion;
selecting a corresponding predetermined etching path by the control unit in accordance with an etching amount of an etched metal layer of the array substrate, and etching the array substrate; and
transporting the etched array substrate into the washing slot and drying the array substrate.
